(19) United States
(12) Patent Application Publication
(10) Pub. No.: US 2003/0174825 A1
(43) Pub. Date: Sep. 18, 2003

(54) Mechanism for automatically substituting calling number information in an integrated access device

(75) Inventors: Arthur Edward Aldridge, Harvest, AL (US); Thomas Kevin Davis, Madison, AL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ADTRAN, INC., Huntsville, AL

(21) Appl. No.: 10/407,795

(22) Filed: Apr. 4, 2003

Related U.S. Application Data
(63) Continuation-in-part of application No. 09/981,047, filed on Oct. 16, 2001.

(51) Int. Cl. H04M 3/42

(52) U.S. Cl. 379/207.15; 379/211.01

(57) ABSTRACT

A calling telephone number information substitution mechanism employs an automated calling number substitution template to selectively modify ‘calling’ party number information that is transmitted to the called party. This serves to associate the calling party who has placed a call that cannot be directly dialed from an outside phone with a valid telephone number identified with the premises originating the call. As a result, the called party, such as a 911 emergency facility, is able to correctly locate and place a return call to a valid telephone number at the premises from which the call has been placed.

### CROSS-REFERENCE TO RELATED APPLICATION

The present application is a continuation-in-part of co-pending U.S. patent application Ser. No. 09/981,047, entitled: “Call-Routing Mechanism for Automatically Performing Number Substitution in an Integrated Access Device” (hereinafter referred to as the '047 application), filed Oct. 16, 2001, by M. Lamy et al, assigned to the assignee of the present application and the disclosure of which is incorporated herein.

### FIELD OF THE INVENTION

The present invention relates in general to communication systems and subsystems and operational control components therefor, and is particularly directed to a calling telephone number information substitution mechanism, which is incorporatable into the call-routing software employed by the microcontroller of a digital communication device, such as an integrated access device (IAD), through which packetized voice and data services are supplied to a customer premises. The calling number information substitution mechanism of the invention automatically selectively modifies the digits of calling telephone number information that is transmitted to the called party, so as to associate the calling party with a valid telephone number that is different from the phone from which the call is placed. Such calling number substitution is particularly useful, where it is necessary that the called party be able to identify a location or premises from which the call is placed, and thereby enable the called party to correctly locate and place a return call to a telephone number at that premises, as in the case of a emergency ‘911’ call.

### BACKGROUND OF THE INVENTION

Digital telecommunication systems, such as time division multiplexed (TDM), digital subscriber loop (DSL), packetized data-based systems, and the like, enable communication service providers to deliver multiple types of digital signalling services to various customer premises equipments. For example, to transport packetized voice and data, the service provider may deploy several different devices, such as asynchronous transfer mode (ATM) switches, digital subscriber line access multiplexers (DSLAMs) and voice gateways, in the signal transport path from a central office to a customer premises-resident device (e.g., IAD).

Because the customer premises device is usually customer-purchased and installed, the service provider does not participate in the customer's choice of what is connected to the link. Still, in order to provide its intended connectivity functionality between customer premises equipment and the public switched telephone network (PSTN), it is necessary that the device's supervisory communications controller conform with the telephone number dialing scheme employed by the network service provider and also that used by the customer premises equipment. Rather than having to reprovision the data terminal equipment or the PSTN switch (a costly and time-consuming exercise), it is desirable that the user be able to modify (e.g., remove, add, replace or substitute) digits of the original number. This serves to provide various operational benefits, such as switch by-pass capability, and also avoids the need to reprovision attached customer premises or PSTN equipment.

Auspiciously, the invention disclosed in the above-referenced '047 application successfully addresses this objective by means of a software-based, call-routing routine installed in the device communications controller,. such as the switch board of an IAD's communications controller, and which incorporates one or more number substitution templates that are associated with various connectivity paths for the communication ports of the device. Each number substitution template is configured to automatically selectively modify one or more digits of an originally dialed telephone number, as necessary, to produce a destination telephone number that conforms with the call connectivity requirements of the communication link serving the called device, and thereby enables the calling party to reach the destination device. Being software-based enables this called number substitution mechanism to offer flexibility in processing the digits of an originally dialed number and the replacement digits of a substitute called number.

### SUMMARY OF THE INVENTION

The present invention takes advantage of the functionality of the automated number substitution template-based mechanism of the '047 application to address a similar, but different problem—the need to modify ‘calling’ party number information, rather than the ‘called’ party number. A non-limiting example of a situation where this need arises involves the placement of an emergency-911 call from a telephone that cannot be directly dialed back from the called number (the 911 emergency service provider).

Consider, for example, the case of a business facility which owns use of the numbers 555-2000 through 555-2049. A third party outside the facility is able to directly dial one of these numbers and gain access to the business. On the other hand, if the facility employs a private branch exchange (PBX), having extensions that do not fall within those of the owned numbers, then an outside calling party dialing one of those PBX extensions would reach a destination other than the business. For example, the PBX may employ in-house extensions 3000 to 3099. If a third party were to dial the number 555-3040, it would not reach the business; instead, it would reach the phone whose number is 555-3040.

Now consider the circumstance where a user of one of such PBX extensions, such as extension 3040, places an emergency 911 call from that phone. In this case, part of the information being routed to the 911 emergency service provider is the telephone number of the calling party, which appears on the service provider's terminal display as 555-3040. As is customary practice in responding to a 911 call, personnel at the emergency service facility will dial back the number (555-3040) appearing on the call intercept display. However, they will not reach the calling party, but rather will call whatever party owns the number 555-3040. Moreover, the accessed geographical address information associated with that number would be different from the address of the facility from which the 911 call originated, so that emergency personnel would not be dispatched to the location sourcing the 911 call.

As pointed out briefly above, pursuant to the invention, this problem is successfully addressed by using the functionality of the automated number substitution template mechanism of the above-referenced '047 application to selectively modify ‘calling’ party number information that is transmitted as part of the set-up of the call, and produce a calling telephone number that is identified with the premises from which the call has been placed and which, if dialed by the called party, will correctly call a telephone at the call-sourcing premises.

In accordance with the invention, when a call is placed, the called number is initially analyzed using a dialed number identification service (DNIS) subroutine in order to determine whether the call is of a type that may require modification of the calling number information. If so, the calling number is analyzed by way of an automatic number identification (ANI) subroutine, to determine whether it is necessary to modify the contents of the calling number information. Upon completion of the DNIS called number analysis subroutine, a “best_DNIS_match_entry” field will indicate whether or not the called number (e.g., 911) is a number which may require the replacement of calling number information by one of the numbers in the ANI substitution template. As noted above, whether or not the calling or ANI number is to be replaced is determined in the ANI substitution routine.

If the contents of the “best_DNIS_match_entry” field has a prescribed value (e.g., null or zero), it is concluded that there is to be no calling number replacement, and both the called (DNIS) number and the originally received calling number information (ANI) are forwarded to the PSTN ‘as is’ or unmodified. However, if the “best_DNIS_match_entry” contains an entry phone number (rather than a null) after stepping through all of the entries of a DNIS template, the process proceeds to the execute the ANI subroutine, to selectively extract a replacement calling number from an ANI substitution template.

Similar to the DNIS subroutine, upon completion of the ANI analysis subroutine, the contents of a “best_ANI_match_entry” field will determine whether or not the originally received calling number requires the replacement with one of the numbers in the substitution template. If, after stepping through all potential number entries of the ANI template, the contents of the “best_ANI_match_entry” field remains a null, it is concluded that there is to be no calling number information replacement, and both the originally called (DNIS) number and calling number information (ANI) are forwarded ‘as is’ or unmodified to the PSTN. On the other hand, where the contents of the “best_ANI_match_entry” are not a null, then the contents of that entry will be forwarded to the PSTN as substitute calling number information. Namely, the originally received ANI number will have been replaced by the ANI template entry that has produced the best match from the “best_ANI_match_entry” field. The ANI subroutine then forwards the called number (e.g., 911) of the DNIS_number field and also the template-based replacement calling number from the ANI_number field to the associated IAD output port.

### BRIEF DESCRIPTION OF THE DRAWINGS

FIG. 1 diagrammatically illustrates a reduced complexity example of a digital telecommunication network, having a communication link coupled from a public switched telephone network to an integrated access device serving customer premises equipment, and incorporating the calling number substitution mechanism of the present invention; and

FIG. 2 is a flow chart of the automated calling number substitution mechanism of the present invention.

### DETAILED DESCRIPTION

Before detailing the automated calling number substitution mechanism of the present invention, it is to be observed that the invention resides primarily in a prescribed communication link establishment mechanism, that is embedded in the communications call-routing control software employed by the supervisory communications controller of a digital communication device, such as an integrated access device. As a consequence, the invention has been illustrated in the drawings in readily understandable block diagram and associated flow chart format, which show only those specific details that are pertinent to the present invention, so as not to obscure the disclosure with details which will be readily apparent to those skilled in the art having the benefit of the description herein. Thus, the block diagram and flow chart illustrations are primarily intended to illustrate the major components of the invention in a convenient functional grouping, whereby the present invention may be more readily understood.

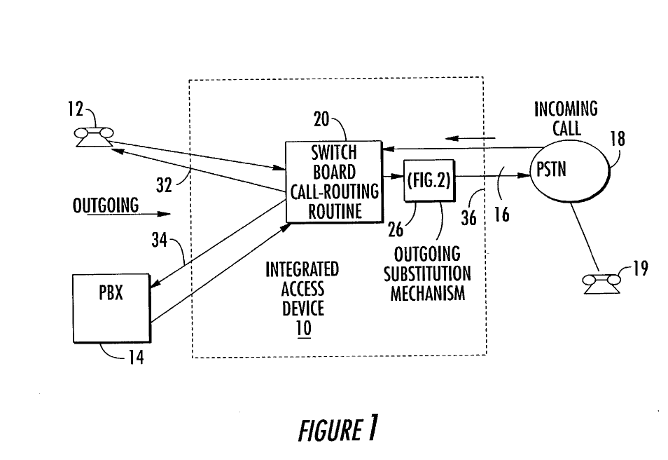

FIG. 1 is a reduced complexity diagrammatic illustration of the interconnection of customer premises-installed digital communication unit 10, such as an integrated access device (IAD) as a non-limiting example, serving various customer premises equipments (CPEs), for example, a telephone 12 and a private branch exchange 14, via a digital communication link 16 of a communication service provider, through which access to a PSTN 18 (serving a remote customer phone 19) is provided. As a non-limiting example, the digital communication unit 10 may comprise an Atlas 850 IAD, manufactured by Adtran Corp., Huntsville, Ala. It should be observed, however, that the invention is not limited to use with this or any other particular communication device, but is intended as an augmentation to the communication supervisory control mechanisms employed in communication devices supplied from a variety of telecommunication equipment manufacturers.

To provide call connectivity between the network and customer premises equipment, the device's communications controller contains what is customarily termed a ‘switch board’ software module 20. This module is operative to route outgoing and incoming calls to respective ones of the device's communication ports, in accordance with original (e.g., dialed destination) number information contained in the call. The port-steering operation of the call-routing switch board is typically governed by initialization parameters with which the device and the CPE equipment have been provisioned at the time of system installation and set-up.

Pursuant to the invention, the switchboard's call-routing routine is augmented to include a calling number substitution template or filter associated with an outgoing connectivity path from the switch board 20 to communication port 26 at the network side of the device. As described briefly above, this calling number substitution template is used selectively modify one or more digits of calling telephone number information that is transmitted as part of the set-up of the call, so as to produce a calling telephone number that is identified with the premises from which the call has been placed and which if dialed by the called party, will call a telephone at that call-sourcing premises.

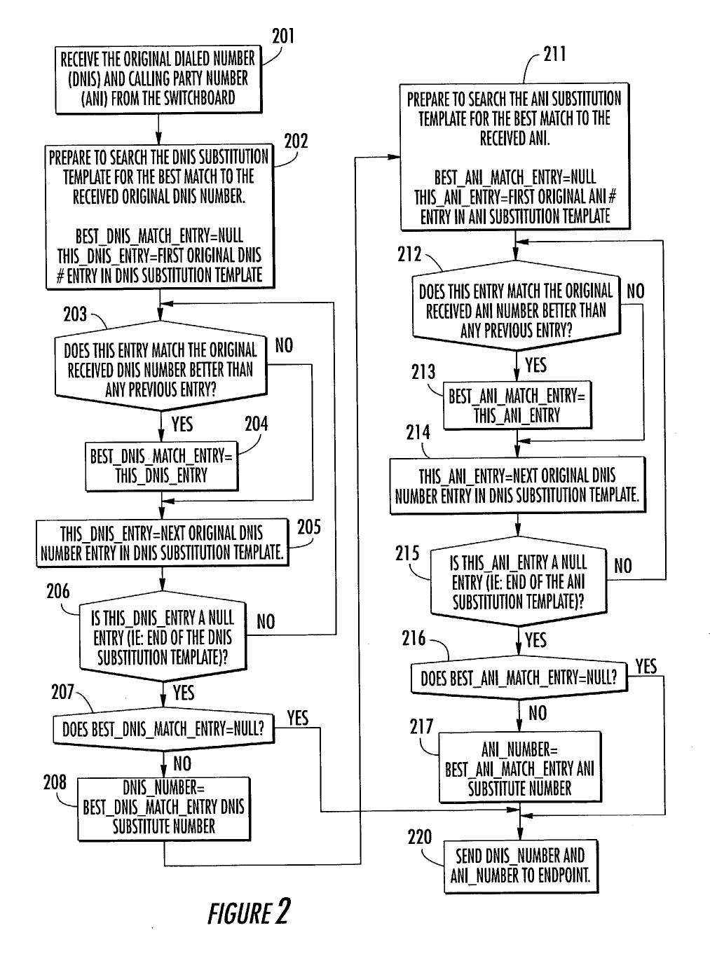

Respective steps of the called number substitution routine carried out by the call-routing augmentation scheme of the present invention are shown in FIG. 2. A non-limiting example of the application of this calling number substitution routine to an emergency 911 call will be described in the course of the explanation of the routine. In accordance with the invention, when a call is placed, the digits of an original number (dialed number identification service or DNIS) as well as the digits of the number of the calling party's phone (automatic number identification or ANI) are presented to the device from CPE equipment, they are received and captured by the switch board at an initial step 201. In response to receipt of this number information, the switch board will call up from memory a pair of number substitution templates, a first of which is associated with the called number, and a second of which is associated with the calling number.

As a non-limiting example, the case of an outgoing emergency 911 call sourced from a telephone extension connected to the PBX 14 will be considered. In the present example, this telephone extension is the number 3456, which falls within a range of extensions 3400-3499 served by the PBX, but does not fall within a range of numbers, such as 555-2000-555-2050, the use of which is currently owned by the premises employing the PBX. While an outgoing call may be placed through the PBX from any of the extensions 3400-3499, no incoming call may be directly dialed to such extensions. Instead, the PBX is set up to intercept calls directed to one or more of the numbers 555-2000-555-2050. The PBX operator then routes the incoming call to the extension for whom the call is intended.

When an outgoing call is placed from a phone served by the PBX, the number of the calling phone is encapsulated as part of the calling number information associated with the call. For the identified central office prefix 555, the calling telephone number information of the present example would be the number 555-3456. As will be described below, this number is selectively modified to one of the numbers owned by the facility from which the call is placed.

Referring again to the flow chart, in step 202, to prepare for conducting an analysis of the called number, in order to determine whether it is necessary to modify the contents of the calling number information, plural comparison table fields of a first, DNIS called number substitution subroutine are loaded with respective initialization values. A first, “best_DNIS_match_entry” field is reset/cleared or set to null (all zeroes). As will be described, upon completion of the DNIS called number analysis subroutine, the contents of the “best_DNIS_match_entry” field will determine whether or not the originally received called number (e.g., 911 in the present example) is a number which may possibly require the replacement of original calling number information (555-3456) by one of the numbers (e.g., one of the numbers 555-2000-555-2050) in the ANI substitution template. Whether or not the calling number is to be replaced is determined in the ANI substitution routine of steps 211-217, to be described. It should be noted that each of the subroutines may accommodate for one or more ‘wild card’ or ‘don't care’ digits (X), to provide for a ‘best match’ of less than all of the digits.

Upon completion or stepping through all of the potential number entries of the DNIS template, if the contents of the “best_DNIS_match_entry” field remains a null, it is concluded that there is to be no calling number replacement, and both the originally called (DNIS) number and the originally received calling number information (ANI) are forwarded ‘as is’ or unmodified. An example of this situation would correspond to a call (emergency or otherwise) placed from one of the numbers 555-2000-555-2050. On the other hand, if the contents of the “best_DNIS_match_entry” are not a null after stepping through all of the entries of the DNIS template, then the process proceeds to a second, ANI subroutine, to extract a replacement number from an ANI substitution template.

In addition to clearing the “best_DNIS_match_entry” field, step 202 also loads a second, “this_DNIS_entry” field with a first entry in the accessed DNIS template. As will be described, the “this_DNIS_entry” field is used in the course of stepping through and comparing the digits of the called number with those of the respective entries of the DNIS template.

As pointed out above, in the present example, the originally received called number is the emergency digit set 911, which is one of the entries in the template. In query step 203, digits of the template number currently stored in the “this_DNIS_entry” field are compared with digits of the originally received number 911, to determine whether the currently examined template number more closely matches the originally received number than any previous entry. In the present example, the values of all the required digits of the two numbers are compared with one another, and a prescribed numerical value (e.g., one) is assigned for each match of a respective digit location; otherwise a zero is assigned for a respective digit.

The sum total of the digit values can then be used to provide a indication of how ‘closely’ the template number ‘matches’ the received number. The higher the total, the greater number of digit matches, and therefore the ‘better’ the match. (In the case of a wild card number, the wild card or don't care digit (X) would be considered a match.)

If none of the digits of the first entry accessed from the number substitution template matches associated digits of the originally received number, then their total is zero, and the answer to query step 203 is NO. In this case, the DNIS subroutine branches to step 205, wherein the “this₁₃ DNIS_entry” field is loaded with the next potential number entry in the template. On the other hand, as long as at least one of the digits of the first number entry accessed from the DNIS template matches an associated digit of the originally received DNIS number, the contents of the “best_DNIS_match_entry” field are replaced with the number currently written into the “this_DNIS_entry” field, and the “this_DNIS_entry” field is then loaded with the next potential number entry in the DNIS template. The contents of the “this_DNIS_entry” field are then examined in step 206 to determine whether the last entry in the number substitution template has been reached. If not (the answer to step 206 is NO), the routine loops back to step 203 and repeats the step and compare sequence, described above.

In the course of stepping through the successive entries of the DNIS template, for the present example, the contents of the “best_DNIS_match_entry” field will eventually be replaced in step 204 with the number 911, which provides the closest match among all entries to that of the original number 911. Subsequently, after repeated iterations through the entirety of the template number substitution list, the last entry (zero) in the template will be reached, so that the answer to query step 206 will be YES, and the routine will then transition to query step 207.

In query step 207, the contents of the “best_DNIS_match_entry” field are examined. As long as one of the numbers in the DNIS template has at least one digit that matches that of the original number, step 204 will have carried out a number substitution and the contents of the “best_DNIS_match_entry” field will be non-zero, so that the answer to query step 207 is NO. In the present example, since the “best_DNIS_match_entry” field contains the (non-zero) number 911, the answer to query step 207 is NO. In this case, the DNIS subroutine transitions to step 208.

In step 208, the originally received DNIS number is replaced by the DNIS template entry that has produced the best match (here, the number 911) from the “best_DNIS_match_entry” field. The DNIS subroutine then transitions to step 211 of the ANI subroutine, to be described. On the other hand, if no potential substitute number in the template has at least one digit that matches that of the original number (including the provision for ‘wild cards’ or ‘don't cares’ (X's)), the contents of the “best_DNIS_match_entry” field will be zero, and the answer to query step 207 would be YES. In this case, the routine branches to step 220, wherein the originally called number (e.g., not 911) of the DNIS_number field and also the calling number from the ANI_number field are forwarded to the associated IAD output port 16.

As pointed out above, in step 208, the originally received DNIS number is replaced by the BNTS template entry that has produced the best match (here, the number 911) from the best_DNIS_match_entry field and the routine then transitions to step 211 of the ANI substitution subroutine. In step 211, in preparation for conducting an analysis of the calling number, in order to determine whether it is necessary to modify the contents of the calling number information, plural comparison table fields of the second, ANI calling number substitution subroutine are loaded with respective initialization values.

In particular, A first, “best_ANI_match_entry” field is reset/cleared or set to null (all zeroes). As will be described, upon completion of the ANI calling number analysis subroutine, the contents of the “best_ANI_match_entry” field will determine whether or not the originally received calling number (e.g., 555-3456 in the present example) requires the replacement with one of the numbers (e.g., one of the numbers 555-2000-555-2050) in the substitution template.

If, after stepping through all of the potential number entries of the ANI template, the contents of the “best_ANI_match_entry” field remains a null, it is concluded that there is to be no calling number information replacement, and both the originally called (DNIS) number and the originally received calling number information (ANI) are forwarded ‘as is’ or unmodified., As pointed out above, an example of this situation would correspond to a call (emergency or otherwise) placed from one of the numbers 555-2000-555-2050. On the other hand, where the contents of the “best_ANI_match_entry” are not a null after stepping through all of the entries of the ANI template, then the contents of that entry will be forwarded to the network. In addition to clearing the “best_ANI_match_entry” field, step 211 also loads a second, “this_ANI_entry” field with a first entry in the accessed ANI template. As will be described, the “this_ANI_entry” field is used in the course of stepping through and comparing the digits of the calling number with those of the entries of the ANI template.

As pointed out above, in the present example, the originally received calling number is the number 555-3456, which is one of the entries in the ANI template. In query step 212, digits of the template number currently stored in the “this_ANI_entry” field are compared with digits of the calling number 555-3456, to determine whether the currently examined template number more closely matches the originally received number than any previous entry. As in the case of the DNIS subroutine, the values of all the required digits of the two numbers are compared with one another, and a prescribed numerical value (e.g., one) is assigned for each match of a respective digit location; otherwise a zero is assigned for a respective digit. The sum total of the digit values can then be used to provide a indication of how ‘closely’ the template number ‘matches’ the received number. The higher the total, the greater number of digit matches, and therefore the ‘better’ the match. (In the case of a wild card number, the wild card or don't care digit (X) would be considered a match.)

If none of the digits of the first entry accessed from the ANI substitution template matches associated digits of the calling number, then their total is zero, and the answer to query step 212 is NO. In this case, the ANI subroutine branches to step 214, wherein the “this_ANI_entry” field is loaded with the next potential number entry in the ANI template. On the other hand, as long as at least one of the digits of the first number entry accessed from the ANI template matches an associated digit of the ANI number, contents of the “best_ANI_match_entry” field are replaced with the number currently stored into the “this_ANI_entry” field, and the “this_ANI_entry” field is then loaded with the next potential number entry in the ANI template. The contents of the “this ANI entry” field are then examined in step 215 to determine whether the last entry in the ANI number substitution template has been reached. If not (the answer to step 215 is NO), the routine loops back to step 212 and repeats the step and compare sequence, described above.

In the course of stepping through the successive entries of the ANI template, for the present example, the contents of the “best_ANI_match_entry” field will eventually be replaced in step 213 with one of the valid numbers (e.g., 555-2056) which provides the closest match among all entries to that of the original number 555-3456. Subsequently, after repeated iterations through the entirety of the ANI template number substitution list, the last entry (zero) in the ANI template will be reached, so that the answer to query step 215 will be YES, and the ANI subroutine will then transition to query step 216.

In query step 216, the contents of the “best_ANI_match_entry” field are examined. As long as one of the numbers in the ANI template has at least one digit that matches that of the original number, step 213 will have carried out a number substitution and the contents of the “best_ANI_match_entry” field will be non-zero, so that the answer to query step 216 is NO. In the present example, since the “best_ANI_match_entry” field contains the (non-zero) 555-2056, the answer to query step 216 is NO, and the subroutine transitions to step 217.

In step 217, the originally received ANI number (555-3456) is replaced by the ANI template entry (555-2056) that has produced the best match from the “best_ANI_match_entry” field. The ANI subroutine then transitions to step 220, wherein the originally called number (e.g., 911) of the DNIS_number field and also the replacement calling number from the ANI_number field (555-2-56) are forwarded to the associated IAD output port 16.

On the other hand, if no potential substitute number in the ANI template has at least one digit that matches that of the original calling number (including the provision for ‘wild cards’ or ‘don't cares’ (X's)), contents of the “best_DNIS_match_entry” field will be zero, and the answer to query step 216 would be YES. In this case, the routine branches directly to step 220, wherein the originally called number (e.g., 911) of the DNIS_number field and also the calling number from the ANI_number field (one of the valid calling numbers 555-2000-555-2050) are forwarded to the associated IAD output port 16.

As will be appreciated from the foregoing description, the calling telephone number information substitution mechanism of the invention uses the functionality of the automated number substitution template-based mechanism of the '047 application to selectively modify ‘calling’ party number information that is transmitted to the called party, so as to associate the calling party with a valid telephone number identified with the premises from which the call is placed, and thereby enable the called party, such as a 911 emergency facility, to correctly locate and place a return call to a telephone number at the premises from which the call has been placed.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein but intend to cover all such changes and modifications as are obvious to one of ordinary skill in the art.

What is claimed

1. A method for enabling a digital communication device to provide, to a called communication circuit being called from a calling communication circuit, information representative of a telephone number other than that associated with said calling communication circuit, said method comprising the steps of:
(a) providing said digital communication device with a calling number substitution mechanism that is operative to automatically selectively modify calling telephone number information, that is associated with said calling communication circuit, and is transported to said called communication circuit in the course of said digital communication device placing a call to said called communication circuit;
(b) processing said calling telephone number information, in accordance with said calling number substitution mechanism, so as to selectively modify said calling telephone number information to produce modified telephone number information representative of said telephone number other than that associated with said calling communication circuit; and
(c) coupling said modified telephone number information to an output port of said digital communication device for transport to said called communication circuit.

2. The method according to claim 1, wherein said digital communication device comprises an integrated access device.

3. The method according to claim 1, wherein, in step (b), said calling number substitution mechanism is operative to compare said calling telephone number with a plurality of original calling numbers, and wherein step (c) comprises, in response to one of said plurality of original calling numbers satisfying a prescribed relationship with said calling telephone number, coupling a substitute telephone number associated with said one original calling number as said modified telephone number information to said output port of said digital communication device.

4. The method according to claim 1, wherein, in step (b), said calling number substitution mechanism is operative to compare said calling telephone number with a plurality of original numbers, and wherein step (c) comprises, in response to one of said plurality of original numbers satisfying a prescribed relationship with said calling telephone number, a substitute telephone number associated with said one original calling number, but in response to none of said plurality of original numbers satisfying said prescribed relationship with said calling telephone number, coupling said calling telephone number to said output port of said digital communication device.

5. The method according to claim 1, wherein said calling number substitution mechanism contains a plurality of potential substitute telephone numbers, and wherein step (c) comprises coupling one of said plurality of potential substitute telephone numbers as said calling telephone number information to said output port of said digital communication device.

6. The method according to claim 1, wherein step (b) comprises comparing said called telephone number with at least one prescribed destination telephone number and, in response to said called telephone number corresponding to one of said at least one destination telephone number, selectively modifying said calling telephone number information to produce modified telephone number information representative of said telephone number other than that associated with said calling communication circuit.

7. The method according to claim 6, wherein step (b) further comprises comparing said calling telephone number with at least one prescribed other telephone number and, in response to said calling telephone number corresponding to none of said at least one prescribed other telephone number, coupling said calling telephone number information to said output port of said digital communication device.

8. The method according to claim 1, wherein step (b) comprises comparing said called telephone number with at least one prescribed destination telephone number and, in response to said called telephone number corresponding to none of said at least one destination telephone number, coupling said calling telephone number information to said output port of said digital communication device.

9. For use with a communications controller of a digital communication device that is configured to enable a customer of a communication service provider to conduct time division multiplexed and packetized voice and data communications with a digital communications switch of a digital telecommunications network, said communications controller containing a call routing mechanism that provides call connectivity of a call, that is coupled to an input port of said digital communication device and has a destination telephone number, to an output port of said digital communication device for delivery to a communication circuit intended to be reached by said destination telephone number, a calling number substitution mechanism comprising:
memory containing a plurality of original telephone numbers; and
a telephone number comparator routine that is operative to compare a calling telephone number with said plurality of original telephone numbers stored in memory, and to selectively modify said calling telephone number information to produce modified telephone number information representative of a telephone number other than that associated with a calling communication circuit.

10. The called number substitution mechanism according to claim 9, wherein said digital communication device comprises an integrated access device.

11. The called number substitution mechanism according to claim 9, wherein said telephone number comparator routine is operative to selectively cause one of a plurality of potential substitute telephone numbers to be coupled as calling party information to said output port of said digital communication device.

12. The called number substitution mechanism according to claim 9, wherein said telephone number comparator routine is operative to compare said calling telephone number with a plurality of original telephone numbers and, in response to one of said plurality of original telephone numbers satisfying a prescribed relationship with said calling telephone number, to couple an associated substitute telephone number as said modified telephone number information to said output port of said digital communication device.

13. The called number substitution mechanism according to claim 9, wherein said telephone number comparator routine is operative to compare said calling telephone number with a plurality of original telephone numbers and, in response to one of said plurality of original telephone numbers satisfying a prescribed relationship with said calling telephone number, to couple an associated substitute telephone number as said as said modified telephone number information to said output port of said digital communication device, but in response to none of said original telephone numbers satisfying said prescribed relationship with said calling telephone number, to couple said calling telephone number to said output port of said digital communication device.

14. The called number substitution mechanism according to claim 9, wherein said memory contains a plurality of original telephone numbers, and wherein said telephone number comparator routine is operative to selectively couple a substitute telephone numbers as said calling telephone number information to said output port of said digital communication device.

15. The called number substitution mechanism according to claim 9, wherein said telephone number comparator routine is operative to compare said called telephone number with at least one prescribed destination telephone number and, in response to said called telephone number corresponding to one of said at least one destination telephone number, to selectively modify said calling telephone number information to produce modified telephone number information representative of said telephone number other than that associated with said calling communication circuit.

16. The called number substitution mechanism according to claim 15, wherein said telephone number comparator routine is operative to compare said calling telephone number with at least one prescribed other telephone number and, in response to said calling telephone number corresponding to none of said at least one prescribed other telephone number, to couple said calling telephone number information to said output port of said digital communication device.

17. The called number substitution mechanism according to claim 9, wherein said telephone number comparator routine is operative compare said called telephone number with at least one original telephone number and, in response to said called telephone number corresponding to none of said at least one original telephone number, to couple said calling telephone number information to said output port of said digital communication device.

18. A telephone number substitution mechanism for use with call-routing software of an integrated access device through which time division multiplexed and packetized voice and data services are supplied, and being configured to automatically selectively modify contents of a calling telephone number as part of call signaling information forwarded to an output port of said integrated access device to a called telecommunication circuit.
